(19) United States
(12) Patent Application Publication
(10) Pub. No.: US 2006/0221182 A1
(43) Pub. Date: Oct. 5, 2006

(54) Security surveillance viewing and recording assembly

(76) Inventor: John C.K. Sham, Hong Kong (HK)

Correspondence Address: Peter S. Canelias;Law Offices of Peter S. Canelias, Suite 2148, 420 Lexington Ave., New York, NY, 10170, US

(21) Appl. No.: 11/097,023

(22) Filed: Apr. 1, 2005

(51) Int. Cl. H04N 7/18

(52) U.S. Cl. 348/155

(57) ABSTRACT

The invention relates to an assembly for installing and maintaining a camera at the entrance door of a house or at an interior door, and for monitoring and recording activity occurring outside of the location. The invention is a complete, easily installed security unit incorporating a miniature CMOS (complementary metal-oxide semiconductor) or CCD (charged-coupled device) camera with sufficient memory storage to retain video and/or audio recordings for security and for message-taking purposes. The apparatus of the unit includes (1) a miniature CMOS/CCD camera with microphone, (2) printed circuit board (PCB) circuits; (3) memory storage; (4) a display device secured to an interior surface of the door; (5) a motion sensor for triggering the operation of the device, and (6) a tube for passing through the door and keeping the components in operable engagement with each other.

### BACKGROUND OF THE INVENTION

1. Field of the Invention

The invention relates to security surveillance and monitoring systems, particularly to an assembly for installing and maintaining a camera and microphone at the entrance door of a house or at an interior door, with video and audio monitoring and recording capabilities. In recent years, surveillance systems have been used for monitoring a visitor at the entrance door of a house. This kind of system typically includes a camera, a power supply, a remote monitor, and a cable including a power cable for supplying power from the power supply to the camera and a signal cable for transmitting a signal between the camera and the monitor.

2. Description of Related Art

In a typical monitoring system, the camera is installed at a position so that the area to be monitored is within the view range of the camera lens with possible supplementation by an additional lens or lenses, with the cable extending from the camera connected to the power supply and a remote monitor placed at a remote location for viewing. With such a structure, an image taken by the camera is viewed on the monitor at the remote location. When the camera is installed in the entrance door of the house, the power supply and the monitor are placed inside the house, and the camera with the cable is fixed to a desired place of the door by a screw or a double-sided adhesive tape, and the like. Examples include U.S. Pat. No. 6,554,499 to Gumpenberger, which discloses an apparatus and process for installing a camera and for supplying close-up images of an individuals face, mounting the camera on a door; U.S. Pat. No. 6,466,261 to Nakamura discloses a door camera unit with a video memory; U.S. Pat. No. 5,907,352 to Gilley discloses another embodiment of a door-mountable security system; U.S. Pat. No. 4,524,384 to Lefkowitz et al. discloses a video and audio system for monitoring an area, particularly an area adjacent a door. The system of Lefkowitz et al. includes a video and audio assembly adapted to be mounted to a door and a video and audio console spaced from the door.

One problem with the conventional structure for installing the camera has been the problem of drilling a hole (or holes) in the entrance door, further complicating the installation process and limiting the adaptability of the surveillance system. In the prior art, there have been attempts to solve this problem by locating the camera at the existing peephole in an exterior door.

For example, U.S. Pat. No. 6,721,501 to Komatsu discloses a camera installed in the entrance door of the house with a frame having an installation hole, and a bolt having a through hole therein particularly adapted for installation at a door peephole. U.S. Pat. No. 6,411,435 to Hall for a Monocular Viewer and Recorder pertains to wide-angle viewers such as the peephole viewers found in residential front doors and further discloses a frame to hold a camera at the peephole viewer.

U.S. Pat. No. 5,594,428 to Peterson discloses a security system that includes a small hand held remote unit which allows a user to communicate with an inside receiver/transceiver. Peterson discloses an optical barrel arrangement that can be a peephole commonly used in doors.

U.S. Pat. No. 4,809,320 to Hawkins et al. for a Door Security System discloses a security intercommunication system which includes an inside housing, an outside housing and a peep-hole optical assembly including a cylindrical body having first and second threadedly engagable, longitudinally aligned sections.

As seen from the above, the prior art has provided many different approaches to the problem of surveillance monitoring, particularly with respect to monitoring the immediate vicinity of the exterior of a door. However, the prior art fails to provide a compact, integrated and easily installed unit with a miniature camera, a motion detector, and with a display panel and function control conveniently positioned on the inside of the door.

### BRIEF SUMMARY OF THE INVENTION

The present invention is a complete, easily installed security unit incorporating a miniature CMOS (complementary metal-oxide semiconductor) or CCD (charged-coupled device) camera with sufficient memory storage to retain video and/or audio recordings for security and for message-taking purposes. The apparatus of the unit includes (1) a miniature CMOS/CCD camera with microphone, (2) printed circuit board (PCB) circuits; (3) memory storage; (4) a display device with attachment means for holding it in position on an interior surface of the door; and (5) a tube for passing through the door and keeping the components in operable engagement with each other.

Generally, a CMOS/CCD camera is installed at a door and is used to capture images and/or audio signals and to generate signals to a video/audio processing center. The signals are then processed and stored in memory storage such as flash memory, hard disk, etc. to provide records for security and message-taking purposes.

In use, when a visitor arrives, the user within the premises is able to view the outdoor situation in real time. The visitor's image is received by the camera and the image is shown on a display device having a screen (TFT, LCD, OLED etc.). If no one is at home to view the image in real time, the system is able to capture videos and store them in the memory storage so that the user is able to recognize previous visitors and to review messages left by previous visitors.

The use of the invention is not limited to exterior doors, since CMOS/CCD cameras may be installed within inside doors to monitor the inside condition of the house or warehouse or office. If an intruder enters, the system will record and store images to help provide information for later investigation.

The assembly is preferably activated by a motion sensor such as those receptive to infra-red or ultrasonic signals. The sensor is also employed to activate the on/off recording for power-saving purposes. This is particularly important for extended absences from the premises, to conserve battery life if a battery power source is used, and to reduce power consumption if household current is used.

Therefore, it is an object of the present invention to provide a complete, easily installed security monitoring and recording assembly for monitoring activity without the premises and for recording such activity.

It is a further object of the present invention to provide a display unit for viewing images obtained through a camera and audio through a microphone.

It is a further object of the present invention to provide a display unit with a screen and screen cover for viewing images obtained through a camera and for protecting the screen.

It is a further object of the present invention to provide a display unit with a control panel for controlling the functions of the assembly.

It is a further object of the present invention to provide a display unit with a receptacle for receiving storage media for viewing images obtained through a camera and audio through a microphone.

It is a further object of the present invention to provide a display unit with a receptacle for receiving and recording to portable storage media cards for recording images and audio.

It is a further object of the present invention to provide a display unit adapted to be secured to the inside of a door and hold the display unit in operable engagement with the camera.

It is a further object of the invention to provide a motion sensor to activate the assembly and trigger recording upon motion being detected outside of the premises.

It is a further object of the invention to provide an attractive, easily installed sensor assembly for securing to the outside of the door of the premises.

It is a further object of the invention to provide a tube such that the sensor, camera and display unit are held in an operably engaged position on the door via a single hole.

Other objects and advantages will be more fully apparent from the following disclosure and the appended claims.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is a section view of a preferred embodiment of the invention installed in a door;

FIG. 2 is a side section view of a preferred embodiment of the invention installed in a door;

FIG. 3 is a schematic of the assembly of the invention;

FIG. 4 is a rear section view of a preferred embodiment of the invention.

### DETAILED DESCRIPTION

The device of the present invention is actually a whole unit or assembly rather than a system. The assembly consists of (1) a miniature digital camera with a microphone for audio pickup; (2) PCB circuits to control operation; (3) memory storage for recording images and audio; and (4) a display unit with an attachment mechanism for securing the display unit to the interior side of the door without interfering with the operation of the unit, preferably a cooperation of screws and a plastic tube. The device is used with motion sensors deployed at the monitored area to trigger recording, such as infra-red or ultrasonic sensing means.

The camera unit is preferably either a CMOS (complementary metal-oxide semiconductor) or CCD (charged-coupled device) camera. The defining difference between digital cameras and those of the film or tape variety is the medium used to record the image. While a conventional camera uses film, digital cameras use an array of digital image sensors. When the shutter opens, rather than exposing film, the digital camera collects light on an image sensor, a solid state electronic device. The image sensor contains a grid of tiny photosites that convert light shining on them to electrical charges. The image sensor may be of the charged-coupled device (CCD) or complementary metal-oxide semiconductor (CMOS) varieties. Most digital cameras employ charge-coupled device (CCD) image sensors, but newer cameras are using image sensors of the complimentary metal-oxide semiconductor (CMOS) variety. Also referred to by the acronym CIS (for CMOS image sensors), this newer type of sensor is less expensive than its CCD counterpart and requires less power.

During camera operation, an image is focused through the camera lens so that it will fall on the image sensor. Depending on a given image, varying amounts of light hit each photosite, resulting in varying amounts of electrical charge at the photosites. These charges can then be measured and converted into digital information that indicates how much light hit each site which, in turn, can be used to recreate the image. When the exposure is completed, the sensor is much like a checkerboard, with different numbers of checkers (electrons) piled on each square (photosite). When the image is read off of the sensor, the stored electrons are converted to a series of analog charges which are then converted to digital values by an Analog-to-Digital (A to D) converter, which indicates how much light hit each site which, in turn, can be used to recreate the image.

In contrast to CCD sensors, which are accessed by row, the CMOS camera chip allows individual pixel access. This makes it possible for the chip to provide a windowing feature that allows selective output of data from a desired portion of the pixel array. This is accomplished by loading vertical and horizontal start and end locations into the registers.

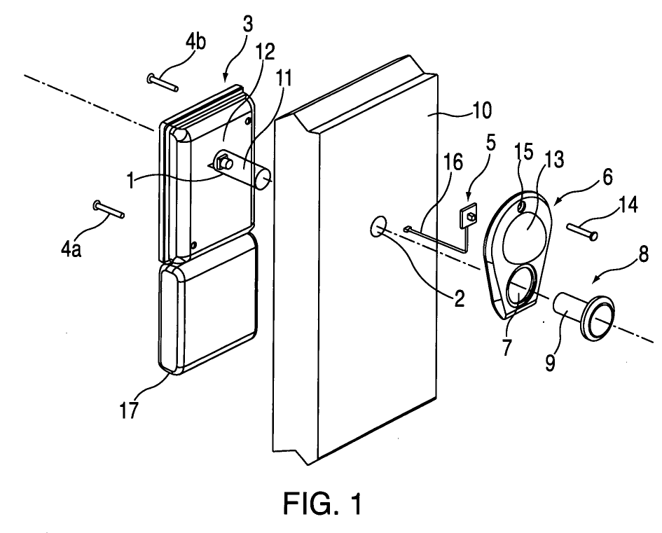

The assembly is designed to be mounted on a door, preferably a door with an existing peephole to avoid the necessity of boring a hole through the door. FIG. 1 illustrates the installation of the unit on the door. The camera 1 is installed within the peephole 2 with the image sensor facing the front side of the door and camera 1 is electronically connected to the display assembly 3. The display assembly 3 preferably has a rectangular box-type shape, and is positioned at the inside surface of the door The PCB circuit, the display and the memory storage are preferably located within the housing of the display assembly 3. The display assembly is preferably secured to the inside door surface by a screws 4a and 4b .

The image sensing assembly consists of the camera 1, a sensor 5, here shown as an infra-red sensor, and a sensor cover 6. The sensor cover 6 has a hole 7 adapted to receive, where applicable, a peephole lens 8. The peephole lens 8 has a tubular portion 9 that extends into hole 2 in door 10. The tubular portion 9 cooperates with a tube 11. The tube 11 is preferably made from a plastic material and may be formed integral with the housing 12 of display unit 3. The tube 11 is also preferably dimensioned so that it may fit within an existing peephole 2 or within a hole bored through the door for the purpose of installing the assembly. Thus the outer diameter of the tube 11 should be less than the inner diameter of the peephole 2 or borehole, but preferably not so much less so that a tolerance between the tube 11 and the peephole 2 allows undue shifting or lateral movement of the tube 11 within the hole 2. The sensor 5 has a front cover 6 that preferably incorporates a semi-spherical cover 13 for covering the sensor 5. Therefore, the semi-spherical cover 13 is preferably formed of a transparent or translucent plastic material when used with a light-sensing type of sensor to permit the light waves to pass through the plastic material to the sensor 5. When used with an ultrasonic sensor, the semi-spherical cover 13 is preferably formed of a plastic material such that the ultrasonic waves will pass through the plastic material to the sensor 5 for detection. The front cover 13 is preferably secured to the door 10 by means of a screw 14 that extends through a preformed hole 15 in the front cover 13.

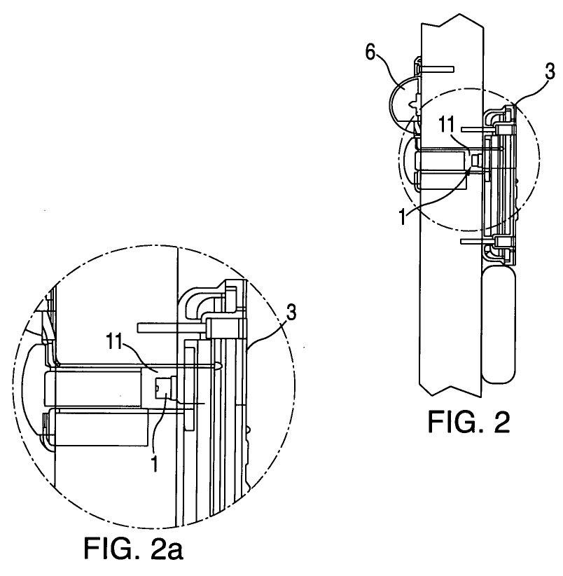

As seen in FIG. 2 and close-up in FIG. 2a, the camera 1 is preferably located within the door 10 and within the plastic tube 11 behind the sensor 5 and the peephole lens 8 so that the camera 1 has an adequate exposure to the outside of the door 10 through the plastic tube 11, the tubular portion 9 of the peephole lens 8 passing through the hole 2 in the door 10. The camera 1 is preferably connected to the sensor 5 by means of a signal cord 16. One or more additional lenses (not shown) may be interposed intermediate the camera 1 and the peephole lens 8. The angle of the peephole lens 8 depends on the image sensor of the camera 1, the distance from the camera 1 to the peephole lens 8, the type of lens employed as the peephole lens (preferably a wide angle or fish-eye type lens) and the desired angle of viewing at the exterior of the premises to be monitored.

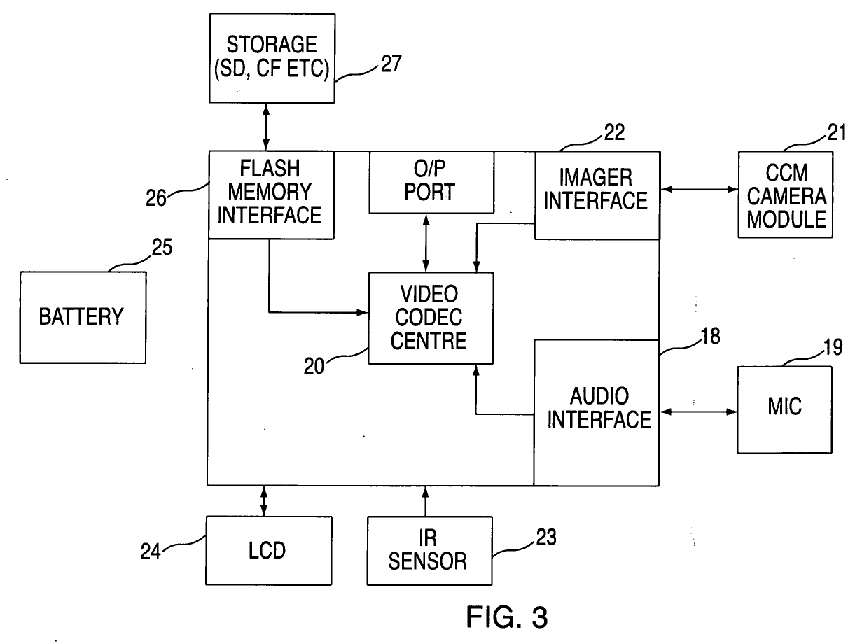

The display assembly 3 preferably includes a slot (not shown) for storage media, here preferably a memory card controller (MCC) that temporarily stores encoded data therein and then writes the data in a memory card through the flash memory interface 26 (FIG. 3). The slot is preferably sized and configured for an available removable storage medium 27 (FIG. 3) such as a MultiMedia Card (MMC). The MMC, which is the standard proposed by the MultiMedia Card Association, is a flash EEPROM card with, for example, approximately 1 GB in capacity. The MMC also reads out stored data from the memory card. The display assembly 3 also preferably includes a battery for supplying power, the battery enclosed within a battery box 17 here attached to the housing 12 of the display assembly 3. The device, however, may use alternative arrangements for the battery or for other power sources such as alternating current.

FIG. 3 shows the connections between the preferred components of the assembly. There is an audio interface 18 for receiving audio signals via the microphone 19. The digitized video and audio data signals from the video and audio digitizers feed into the media data formatter that includes both video compressors and audio compressors within the video codec centre 20. The video and audio compressors are preferably combined as shown in FIG. 3, but may be separate. The video and audio compressors may include a volatile or non-volatile memory.

A compressor such as these is often called a “codec” which is short for compressor/decompressor. A codec is any technology for compressing and decompressing data. Codecs may be implemented in software, hardware, firmware, or some combination. Some popular codecs for computer video include MPEG, Indeo, and Cinepak. Some popular codecs for computer audio include RealAudio and Windows Media Audio.

Although the term “codec” inherently includes a decompressor, references herein to a “codec” only require the compressor portion, but may optionally including the decompressor portion. The digital media data is compressed. Codecs accomplish this compression. Typically, the video codec is Windows Media Video and the audio codec is Windows Media Audio. Alternatively, the video codec may be any functionally similar codec, such as MPEG-4. Alternatively, the audio codec may any codec functionally similar to the Windows Media Audio. The compressed media data is formatted into an ISM format. Typically, the compressed media data is formatted in ASF.

FIG. 3 also shows a CCM Camera Module 21 that is operably coupled with an imager interface 22 for transmission to the Video Codec Centre 20. Within this framework, there is further provided means for selecting stations to be driven by a camera control module (CCM), asserting a display in the user feedback section of the CCM 1 and communicating as necessary the input of an input device to the camera to be controlled. FIG. 3 shows an infra-red type sensor 23, but an alternative type of motion sensor may be used. There is shown an LCD (liquid crystal display) 24 that is viewable from the rear of the display assembly 3, but an alternative type of image display such as a TFT may be employed. The preferred embodiment of FIG. 3 also shows a battery 25 as the power source. This is preferred since it is expected that the door will swing inwards and a cord for providing alternating current to the unit may prove cumbersome in use. However, it is possible to employ AC power in the unit with appropriate cord control.

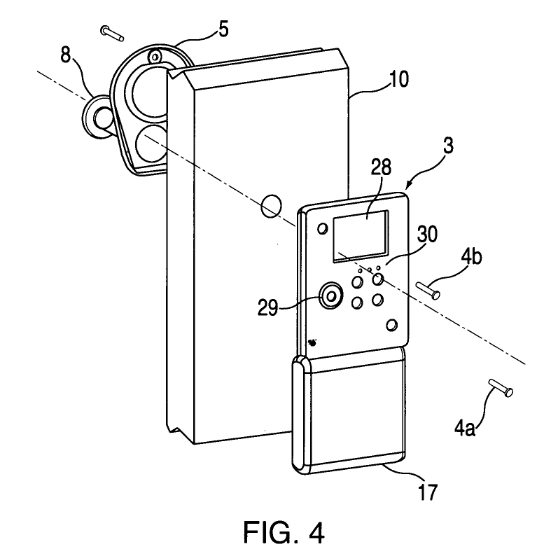

FIG. 4 shows the rear view of the display assembly 3. The display assembly 3 preferably includes a viewing screen 28 having a clear cover made from an acrylic material. The assembly is activated via a power button 29 so that power may be turned on and off by the user from within the premises. LED indicators 30 are provided so that the power status of the system may be determined at a glance. A speaker (not shown) is also provided for playing audio recordings. The unit is controlled by means of a function panel preferably located below the display 28 and above the battery box 17, and easily accessible to the user. The function panel may include dedicated buttons for particular commands as well as an interactive command function coordinated with selections displayed on the display 28. A user may toggle through the available selections and press an “enter” button when the desired function is highlighted.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. An assembly for monitoring and recording activity comprising:
a motion sensor for detecting motion outside of an enclosed location and positioned on an exterior surface outside of the enclosed location;
a microphone for receiving audio input;
a camera for receiving images, the camera located within a tube between the exterior surface and the interior surface;
a display unit operably connected to the camera and having a screen for viewing images and a speaker for listening to audio input, the display unit being adapted to receive a recording medium for recording the images and audio input;
the display unit being associated with the tube, the tube extending from a rear portion of the display unit through the interior surface within the enclosed location;
the display unit being secured to the inner surface in the enclosed location.

2. The assembly of claim 1, wherein the motion sensor comprises an infra-red detector.

3. The assembly of claim 1, wherein the motion sensor comprises an ultra-sonic detector.

4. The assembly of claim 1, wherein the tube is formed of a plastic material.

5. The assembly of claim 1, wherein the camera comprises a charged-coupled device.

6. The assembly of claim 1, wherein the camera comprises a complementary metal-oxide semiconductor.

7. The assembly of claim 1, wherein the screen has an acrylic plastic covering.

8. The assembly of claim 1, wherein the display unit further comprises a memory card slot for receiving a memory card.

9. The assembly of claim 1, wherein the display unit further comprises a control panel for controlling functions of the assembly.

10. The assembly of claim 1, wherein the display unit has a battery box for housing a battery, the battery supplying power to the display unit.

11. An assembly for monitoring and recording activity comprising:
a motion sensor for detecting motion outside of an enclosed location and positioned on a surface exterior to the enclosed location;
the motion sensor having a housing with a front cover;
a microphone for receiving audio input;
a camera for receiving images, the camera located within a tube between the exterior surface and the interior surface;
a display unit operably connected to the camera and having a screen for viewing images and a speaker for listening to audio input, the display unit being adapted to receive a recording medium for recording the images and audio input;
the display unit having a housing, the housing having the tube formed integral therewith, the tube extending through the interior surface within the enclosed location;
the display unit being secured to the inner surface in the enclosed location.

12. The assembly of claim 11, wherein the front cover further comprises a semi-spherical protrusion covering the motion sensor.

13. The assembly of claim 11, wherein the motion sensor comprises an infra-red detector.

14. The assembly of claim 11, wherein the motion sensor comprises an ultra-sonic detector.

15. The assembly of claim 11, wherein the tube is formed of a plastic material.

16. The assembly of claim 1 1, wherein the camera comprises a charged-coupled device.

17. The assembly of claim 11, wherein the camera comprises a complementary metal-oxide semiconductor.

18. The assembly of claim 1, wherein the screen has an acrylic plastic covering.

19. The assembly of claim 1, wherein the display unit further comprises a memory card slot for receiving a memory card.

20. The assembly of claim 1, wherein the display unit further comprises a control panel for controlling functions of the assembly.

21. An assembly for monitoring and recording activity comprising:
motion sensing means for detecting motion outside of an enclosed location and positioned on an exterior surface outside of the enclosed location;
a microphone for receiving audio input;
a camera for receiving images, the camera located within a tube between the exterior surface and the interior surface;
a display unit operably connected to the camera and having a viewing means for viewing images and a speaker for listening to audio input, the display unit being adapted to receive a recording medium for recording the images and audio input;
the display unit being associated with the tube, the tube extending from a rear portion of the display unit through the interior surface within the enclosed location;
the display unit being secured to the inner surface in the enclosed location.

22. The assembly of claim 21, wherein the tube is formed of a plastic material.

23. The assembly of claim 21, wherein the camera comprises a charged-coupled device.

24. The assembly of claim 21, wherein the camera comprises a complementary metal-oxide semiconductor.

25. The assembly of claim 21, wherein the display unit further comprises a means for receiving a memory card.

26. The assembly of claim 21, wherein the display unit further comprises a control panel for controlling functions of the assembly.

27. The assembly of claim 21, wherein the display unit has a battery box for housing a battery, the battery supplying power to the display unit.
